(19) United States
(12) Patent Application Publication
(10) Pub. No.: US 2025/0335514 A1
(43) Pub. Date: Oct. 30, 2025

(54) DOCUMENT DISPLAY METHOD AND DEVICE RELATED THERETO

(71) Applicant: Beijing Zitiao Network Technology Co., Ltd., Beijing (CN)

(72) Inventors: Shuang Zhang, Beijing (CN); Zhou Yu, Beijing (CN)

(21) Appl. No.: 18/855,569

(22) PCT Filed: Apr. 11, 2023
(86) PCT No.: PCT/CN2023/087451

§ 371 Date: Oct. 9, 2024

(30) Foreign Application Priority Data
Apr. 25, 2022 (CN) 202210439168.7

(51) Int. Cl. G06F 16/93

(52) U.S. Cl. CPC G06F 16/93

(57) ABSTRACT

The present application discloses a document display method and a device related thereto. The method comprises after receiving a first access request triggered by a first user on a first document, determining whether historical browsing status data of a second document exists based on an identifier to be used carried in the first access request for uniquely identifying the second document, controlling a display of the second document based on the identifier to be used and the historical browsing status data of the second document when it is determined that the historical browsing status data of the second document exists, such that the second document can be displayed based on a browsing status recorded by the historical browsing status data, and the second document being displayed can be restored to the browsing status presented by the second document when the second document was displayed at the last time.

This application claims priority to Chinese Application No. 202210439168.7 filed on Apr. 25, 2022, to China National Intellectual Property Administration and titled “a document display method and a device related thereto”, the disclosures of which are incorporated herein by reference in their entities.

### FIELD

The present application relates to the field of data processing technology, and in particular, to a document display method and a device related thereto.

### BACKGROUND

For some application scenarios (for example, video conference), a main sharer can share documents during an interaction process, such that at least one sharee can follow a document browsing behavior of the main sharer to browse a document. For example, when the main sharer browses to page 3 on a shared document, each sharee can follow the main sharer to browse to page 3. Video conference (VC) refers to a remote transmission of resource data (such as sound, images, documents, etc.) between multiple users through a hardware device in a conference room or an application installed on the client, in order to achieve real-time and interactive communication, which can effectively solve a cost problem caused by meeting in spatial distance.

However, due to a shortcoming in document sharing way mentioned above, an effect of document sharing is poor, which can easily lead to a poor user experience in document sharing.

### SUMMARY

In order to solve the above technical problems, the present application provides a document display method and a device related thereto, which can improve the effect of document sharing and thereby enhancing the user experience in document sharing.

In order to achieve the above objectives, the technical solutions provided by the embodiments of the present application are as follows:

Embodiments of the present application provide a document display method. The method comprises: receiving a first access request triggered by a first user on a first document, wherein the first access request carries an identifier to be used, and wherein the identifier to be used is used to identify a second document; determining whether historical browsing status data of the second document exists based on the identifier to be used; and in accordance with a determination that the historical browsing status data exists, controlling a display of the second document based on the identifier to be used and the historical browsing status data.

In a possible implementation, the controlling the display of the second document based on the identifier to be used and the historical browsing status data comprises: displaying the second document to the first user based on the identifier to be used; and controlling a browsing status of the second document based on the historical browsing status data, when it is determined that the second document is in a display status.

In a possible implementation, the method further comprises after receiving the first access request triggered by the first user on the first document: acquiring first browsing status data, wherein the first browsing status data is used to describe a browsing status of the first document when the first access request is triggered; and establishing a correspondence between a first identifier and the first browsing status data, wherein the first identifier is used to identify the first document.

Wherein the determining whether historical browsing status data of the second document exists based on the identifier to be used comprises: determining whether there is a correspondence comprising the identifier to be used, to obtain a determination result to be used; and determining whether the historical browsing status data of the second document exists based on the determination result to be used.

In a possible implementation, the determining whether the historical browsing status data of the second document exists based on the determination result to be used comprises: in accordance with a determination that the determination result to be used indicates that there is the correspondence comprising the identifier to be used, extracting the historical browsing status data of the second document from the correspondence comprising the identifier to be used; and in accordance with a determination that the determination result to be used indicates that there is no correspondence comprising the identifier to be used, determining that the historical browsing status data of the second document does not exist.

In a possible implementation, the method further comprises after the controlling the display of the second document based on the identifier to be used and the historical browsing status data: deleting the historical browsing status data of the second document.

In a possible implementation, the method further comprises: obtaining second browsing status data, after receiving a second access request triggered by the first user on the second document, wherein the second browsing status data is used to describe a browsing status of the second document when the second access request is triggered; and establishing a correspondence between the identifier to be used and the second browsing status data.

In a possible implementation, the method further comprises: in accordance with a determination that the historical browsing status data does not exist, displaying the second document to the first user based on the identifier to be used.

In a possible implementation, the method further comprises: in accordance with a determination that the first user meets a preset user condition, displaying the second document to the second user based on a process of controlling of the display of the second document when it is determined that the second user meets a follow-up reading condition.

In a possible implementation, the second user is determined based on a document sharing scope.

In a possible implementation, the document sharing scope is determined based on a current conference participant.

Embodiments of the present application also provide a document display method for applying to a first interaction module. The method comprises: receiving a first access request triggered by a first user on a first document, wherein the first access request carries an identifier to be used, and wherein the identifier to be used is used to identify a second document; and sending the identifier to be used to a first processing module, and sending, after obtaining historical browsing status data of the second document, the historical browsing status data to the first processing module, such that the first processing module controls a display of the second document based on the identifier to be used and the historical browsing status data, wherein the historical browsing status data is obtained based on the identifier to be used.

In a possible implementation, the method further comprises: generating a document jump instruction based on the identifier to be used.

Wherein the sending the identifier to be used to the first processing module comprises: sending the document jump instruction to the first processing module, such that the first processing module displays the second document to the first user based on the identifier to be used carried by the document jump instruction.

Wherein the sending the historical browsing status data to the first processing module comprises: sending the historical browsing status data to the first processing module after obtaining a status data query request sent by the first processing module, such that the first processing module controls a browsing status of the second document based on the historical browsing status data, wherein the status data query request is used to request the first interaction module to provide the historical browsing status data.

In a possible implementation, the method further comprises: sending, after obtaining the status data query request sent by the first processing module, preset information to the first processing module in accordance with a determination that the historical browsing status data does not exist, wherein the preset information is used to indicate that the historical browsing status data does not exist in the first interaction module.

In a possible implementation, the method further comprises after the sending the document jump instruction to the first processing module: obtaining first browsing status data sent by the first processing module, wherein the first browsing status data is used to describe a browsing status of the first document when the first access request is triggered; and establishing a correspondence between a first identifier and the first browsing status data, wherein the first identifier is used to identify the first document.

Wherein a process of obtaining the historical browsing status data comprises: determining, after obtaining the correspondence comprising the identifier to be used, the historical browsing status data of the second document from the correspondence comprising the identifier to be used.

In a possible implementation, the method further comprises: deleting the historical browsing status data of the second document after obtaining control complete information sent by the first processing module. Wherein the control complete information is used to indicate that the first processing module has completed the controlling of the display of the second document.

In a possible implementation, the method further comprises: in accordance with a determination that the first user meets a preset user condition, sending a document follow-up instruction to a second interaction module when it is determined that a second user meets a follow-up reading condition, such that the second interaction module controls a second processing module to follow up the controlling of the display of the second document by the first processing module.

In a possible implementation, the second user is determined based on a document sharing scope.

In a possible implementation, the document sharing scope is determined based on a current conference participant.

An embodiment of the present application also provides a document display method for applying to a first processing module. The method comprises: receiving an identifier to be used and historical browsing status data of a second document sent by a first interaction module when the first processing module is displaying a first document, wherein the identifier to be used is used to identify the second document; and controlling a display of the second document based on the identifier to be used and the historical browsing status data of the second document, such that the first processing module starts to display the second document.

In a possible implementation, the controlling the display of the second document comprises: displaying, after receiving a document jump instruction sent by the first interaction module, the second document to a first user based on an identifier to be used carried by the document jump instruction; generating a status data query request based on the identifier to be used when it is determined that the second document is in a display status; sending the status data query request to the first interaction module; obtaining a status data query result fed back by the first interaction module, for the status data query request; and in accordance with a determination that the status data query result carries the historical browsing status data of the second document, controlling a browsing status of the second document based on the historical browsing status data.

In a possible implementation, the method further comprises: in accordance with a determination that the status data query result indicates that the historical browsing status data of the second document does not exist in the first interaction module, controlling the display of the second document based on a preset browsing status data.

In a possible implementation, the method further comprises after receiving the document jump instruction sent by the first interaction module: sending first browsing status data to the first interaction module, wherein the first browsing status data is used to describe a browsing status of the first document when receiving the document jump instruction sent by the first interaction module.

In a possible implementation, the first browsing status data is determined based on a historical browsing operation of the first user on the first document, and the historical browsing operation is used to indicate a document browsing operation triggered by the first user on the first document before receiving the document jump instruction sent by the first interaction module.

In a possible implementation, the first browsing status data is determined based on document location information of the identifier to be used, and the document location information is used to indicate a position of the identifier to be used on the first document.

In a possible implementation, the method further comprises after controlling the display of the second document based on the identifier to be used and the historical browsing status data of the second document: generating control complete information based on the identifier to be used; and sending the control complete information to the first interaction module, such that the first interaction module deletes the historical browsing status data of the second document.

An embodiment of the present application also provides a document display device. The document display device comprises:
a first receiving unit configured to receive a first access request triggered by a first user on a first document; wherein the first access request carries an identifier to be used; the identifier to be used is used to identify a second document;
a first determining unit configured to determine whether historical browsing status data of the second document exists based on the identifier to be used;
a first controlling unit configured to control a display of the second document based on the identifier to be used and the historical browsing status data, in accordance with a determination that the historical browsing status data exists.

The embodiment of the present application further provides a first interaction module. The first interaction module comprises:
a second receiving unit configured to receive a first access request triggered by a first user on a first document; wherein the first access request carries an identifier to be used; and the identifier to be used is used to identify a second document;
a first sending unit configured to send the identifier to be used to the first processing module, and send the historical browsing status data to the first processing module after obtain historical browsing status data of the second document, such that the first processing module controls a display of the second document based on the identifier to be used and the historical browsing status data. Wherein the historical browsing status data is obtained based on the identifier to be used.

The embodiment of the present application also provides a first processing module. The first processing module comprises:
a second controlling unit configured to receive an identifier to be used and historical browsing status data of a second document sent by a first interaction module when the first processing module is displaying a first document; control a display of the second document based on the identifier to be used and the historical browsing status data of the second document, such that the first processing module starts to display the second document. Wherein the identifier to be used is used to identify the second document.

The embodiment of the present application also provides a document display system. The document display system comprises any of the first interaction module provided in the embodiment of the present application and any of the first processing module provided in the embodiment of the present application.

The embodiment of the present application also provides a device, which comprises a processor and a memory. The memory is configured to store a computer program. The processor is configured to execute any implementation of the document display method provided in the embodiment of the present application based on the computer program.

The embodiment of the present application also provides a computer-readable storage medium. The computer-readable storage medium is configured to store a computer program, and the computer program is configured to execute any implementation of the document display method provided in the embodiment of the present application.

The embodiment of the present application also provides a computer program product. When the computer program product is run on a terminal device, the terminal device executes any implementation of the document display method provided in the embodiment of the present application.

Compared with the prior art, the embodiments of the present application have at least the following advantages:

In the technical solution provided by the embodiment of the present application, after receiving a first access request triggered by a first user on a first document, it is determined whether historical browsing status data of the second document exists based on the identifier to be used carried by the first access request for uniquely identifying the second document. Such that when it is determined that the historical browsing status data of the second document exists, a display of the second document is controlled based on the identifier to be used and the historical browsing status data of the second document. Such that the second document can be displayed based on a browsing status (for example, status information such as which page is browsed to) recorded by the historical browsing status data. Such that the second document being displayed can be restored to a browsing status presented by the second document when the second document was displayed at the last time. This can effectively overcome an adverse effect caused by document jump, thereby improving the effect of document sharing and enhancing the user experience in document sharing.

### BRIEF DESCRIPTION OF THE DRAWINGS

In order to more clearly illustrate the embodiments of the present application or the technical solutions in the prior art, the drawings required for use in the embodiments or the description of the prior art will be briefly introduced below. Obviously, the drawings described below are only some embodiments recorded in the present application. For ordinary technicians in the field, other drawings can be obtained based on these drawings without paying creative work.

FIG. 1 is a flow chart of a document display method provided in an embodiment of the present application;

FIG. 2 is a schematic diagram of a multi-module interaction process provided in an embodiment of the present application;

FIG. 3 is a schematic diagram of another multi-module interaction process provided in an embodiment of the present application;

FIG. 4 is a schematic diagram of the structure of a document display device provided in an embodiment of the present application;

FIG. 5 is a schematic diagram of the structure of a first interaction module provided in an embodiment of the present application;

FIG. 6 is a schematic diagram of the structure of a first processing module provided in an embodiment of the present application;

FIG. 7 is a schematic diagram of the structure of a document display system provided in an embodiment of the present application.

### DETAILED DESCRIPTION OF EMBODIMENTS

In a research on document sharing technology, the inventor found that for some document sharing technologies, if a document A is in a shared status (that is, a status in which the main sharer and multiple sharees are browsing the document A), and the document A comprises a link to a document B, the main sharer (or the sharee in a free reading status) can jump from the document A to the document B by clicking on the link to the document B, such that the document B is in the shared status. However, when returning to the document A from the document B, a top position of the document A is usually displayed directly, and a reading position before the jump of the document A cannot be positioned. The main sharer (or, the sharee who is in the free reading status) often needs to manually adjust the document A to the reading position before the jump, which results in a poor user experience in document sharing.

Based on the above findings, in order to solve the technical problems shown in the background, embodiments of the present application provide a document display method. The method comprises: after receiving a first access request triggered by a first user on a first document, determining whether there is historical browsing status data of a second document based on an identifier to be used carried by the first access request for uniquely identifying the second document. Such that when it is determined that the historical browsing status data of the second document exists, controlling a display of the second document based on the identifier to be used and the historical browsing status data of the second document. Such that the second document can be displayed based on a browsing status (for example, status information such as which page is browsing to) recorded by the historical browsing status data. The second document being displayed can be restored to the browsing status presented by the second document when the second document was displayed at the last time. This can effectively overcome the problems caused by document jump, thereby improving the effect of document sharing and enhancing the user experience in document sharing.

In addition, the embodiments of the present application do not limit the execution subject of the document display method. For example, the document display method provided by the embodiments of the present application can be applied to data processing device such as a terminal device or server. The terminal device can be a smartphone, a computer, a Personal Digital Assistant (PDA) or a tablet computer, etc. The server can be a standalone server, a cluster server or a cloud server.

As another example, in some application scenarios, the document display method provided by the embodiments of the present application can use at least one functional module (for example, the “first interaction module”, “first processing module”, “second interaction module” and “second processing module” shown below) for implementation.

In order to enable those skilled in the art to better understand the present application, the technical solutions in the embodiments of the present application will be clearly and completely described below in conjunction with the drawings in the embodiments of the present application. Obviously, the described embodiments are only part of the embodiments of the present application, not all of the embodiments. Based on the embodiments in the present application, all other embodiments obtained by ordinary technicians in the field without creative work are within the scope of protection of the present application.

To facilitate understanding of the present application, the document display method provided in the embodiments of the present application is described below with reference to the accompanying drawings.

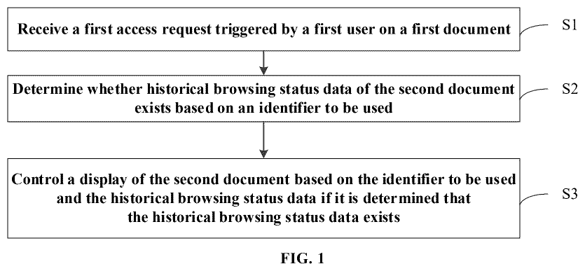

Refer to FIG. 1, which is a flowchart of a document display method provided in an embodiment of the present application.

The document display method provided in the embodiment of the present application comprises S1-S3.

S1: Receiving a first access request triggered by a first user on a first document.

The above-mentioned “first user” refers to a user who is browsing the first document. The embodiment of the present application does not limit the “first user”. For example, if the first document is in a shared status, the “first user” may be the main sharer or a sharee in a free reading status.

It should be noted that the above-mentioned “main sharer” refers to the user who shares the first document with other people, the above-mentioned “sharee in the free reading status” refers to the user who freely reads the shared first document (that is, in non-follow-up status). For example, when user 1, user 2 and user 3 are having a video conference, user 1 can share the first document with user 2 and user 3, such that user 2 and user 3 in the follow-up status can browse the first document with user 1. However, if user 3 wants to control a browsing progress for the first document by himself, user 3 can trigger the free reading instruction to switch the reading mode for the first document from the follow-up status to the free reading status. Such that user 3 can control browsing of the first document by himself. Based on this, it can be seen that user 1 is the main sharer, user 2 is the sharee in the follow-up status, and user 3 is the sharee in the free reading status.

The above-mentioned “first document” is used to indicate a document being shared (that is, the document before jumping). The embodiment of the present application does not limit the “first document”. For example, the “first document” may be an online document.

It should be noted that the characteristics of the above-mentioned “online document” comprise: \hat{1} It has the attributes of being shareable and collaborative. \hat{2} It can be stored in the cloud. \hat{3}Uniform Resource Locator (URL) can be used to uniquely indicate a document storage address.

The above-mentioned “first access request” is used to request to jump from the first document to the second document. The second document is used to indicate the shared document after jumping. For example, when the first document is document A and the second document is document B, the “first access request” can be used to request to jump from document A to document B.

The above-mentioned “first access request” carries an identifier to be used. The identifier to be used is used to uniquely identify the second document. The embodiment of the present application does not limit the identifier to be used. For example, the identifier to be used may be the URL of the second document.

The embodiments of the present application do not limit a triggering mode of the above-mentioned “first access request”. For example, if there is a URL of the second document in the first document, the first user can trigger the first access request by clicking on “the URL of the second document” in the first document.

For another example, after jumping from the second document to the first document, a return button can appear on the first document. Such that the first user can trigger the first access request by clicking the return button in the first document to return to the second document from the first document.

Based on the relevant content of S1 above, it can be known that when the first user is browsing the first document, if the first user wants to read the second document, the first user can trigger the first access request on the first document. Such that the purpose of jumping from the first document to the second document can be achieved later based on the identifier to be used carried in the first access request.

S2: Determining whether historical browsing status data of the second document exists based on the identifier to be used.

The above-mentioned “historical browsing status data of the second document” is used to describe a browsing status (for example, a final browsing position, etc.) reached by the second document during a historical browsing process of the second document.

In addition, the embodiments of the present application do not limit the above-mentioned “historical browsing status data of the second document”, for example, it may comprise: previous browsing status data of the second document. The above-mentioned “previous browsing status data of the second document” is used to describe a browsing status (for example, a previous final browsing location, etc.) reached by the second document during a browsing process of the second document which is closest to the current moment.

Based on the relevant content of S2 above, it can be known that after obtaining the first access request, it can be determined whether historical browsing status data of the second document exist based on the identifier to be used carried by the first access request. If the historical browsing status data of the second document exists, it indicates that the second document has been browsed before. Therefore, the display status of the second document can be controlled by referring to the historical browsing status data of the second document. Such that the second document currently displayed can be restored to the browsing status presented by the second document when it was displayed for the last time. If the historical browsing status data of the second document does not exist, it indicates that the second document is browsed for the first time, so a top position of the second document can be directly displayed.

S3: If it is determined that the historical browsing status data of the second document exists, controlling a display of the second document based on the identifier to be used and the historical browsing status data of the second document.

In an embodiment of the present application, after it is determined that the historical browsing status data of the second document exists, it can be determined that the second document has been browsed before. Therefore, the display of the second document can be controlled based on the identifier to be used and the historical browsing status data of the second document. The second document can be displayed to the first user based on the browsing status (for example, the final browsing position of the previous browsing, etc.) described by the historical browsing status data. Such that the first user can continue browsing the second document based on the browsing status described by the historical browsing status data, which is beneficial to improving the user experience in document sharing.

Based on the relevant contents of S1 to S3 above, it can be known that for the document display method provided in the embodiment of the present application, after receiving the first access request triggered by the first user on the first document, it is determined whether historical browsing status data of the second document exists based on the identifier to be used carried by the first access request for uniquely identifying the second document. Such that when it is determined that the historical browsing status data of the second document exists, the display of the second document is controlled based on the identifier to be used and the historical browsing status data of the second document. Such that the second document can be displayed based on the browsing status (for example, status information such as which page was browsed to at last time) recorded in the historical browsing status data. Such that the second document being displayed can be restored to the browsing status presented by the second document when the second document was displayed for the last time. This can effectively overcome an adverse effect caused by document jump, thereby improving the effect of document sharing and enhancing the user experience in document sharing.

In order to further improve the effect of document sharing, the embodiment of the present application further provides a possible implementation for S3 above, which may specifically comprise S31-S32.

S31: Displaying the second document to the first user based on the identifier to be used.

As an example, when the above “identifier to be used” is the URL of the second document, S31 may specifically be: opening the second document based on the identifier to be used. Such that the first user can see the jump from the first document to the second document.

S32: Controlling the browsing status of the second document based on the historical browsing status data of the second document, when it is determined that the second document is in the display status.

In the embodiment of the present application, the browsing status of the second document is controlled (for example, browsing position is controlled, etc.) based on the historical browsing status data of the second document, when it is determined that the second document is in the display status. Such that the second document can be restored to the browsing status presented by the second document when the second document was displayed for the last time.

Based on the relevant contents of S31 to S32 above, after obtaining the identifier to be used, the second document is opened based on the identifier to be used. And then when the second document is in the open status, the second document is rendered according to its historical browsing status data. Such that the second document can be restored to the browsing status presented by the second document when the second document was displayed for the last time. The first user can continue reading based on the previous browsing status of the second document. This is beneficial for improving the user experience in document sharing.

In addition, in order to better search historical browsing status data of a document, a correspondence between the document identifier of pre-jump document and the current browsing status data of pre-jump document can be established during each document jump. Such that in the next display process of the “pre-jump document”, a rendering initial value of the browsing status of the “pre-jump document” can be determined based on this correspondence. Based on this, the embodiment of the present application also provides another possible implementation of the above-mentioned “document display method”, in which the document display method not only comprises the above-mentioned S1-S3, but also may comprise S4-S5:

S4: Obtaining first browsing status data.

The above-mentioned “first browsing status data” is used to describe the browsing status of the first document when the first access request is triggered.

In addition, the embodiment of the present application does not limit the method for obtaining the above-mentioned “first browsing status data”. For ease of understanding, two examples are used for explanation below.

Example 1, the above-mentioned “first browsing status data” can be determined based on the historical browsing operation of the first user on the first document. The “historical browsing operation” is used to indicate the document browsing operation triggered by the first user on the first document before the first access request is triggered.

The above-mentioned “document browsing operation” refers to a browsing operation performed on a document when the user browses the document. The embodiment of the present application does not limit the “browsing operation”. For example, the “browsing operation” may comprise: scroll position, selecting a comment, opening a picture, the picture display ratio, highlighting a cell in a table, dragging the table left and right (such that the part displayed on the page is changed), highlighting comments, zoom status, etc.

Based on the above relevant content of Example 1, it can be known that after the first user triggers the first access request on the first document, all document browsing operations that have been triggered by the first user on the first document can be summarized to obtain first browsing status data. Such that the first browsing status data can indicate the browsing status of the first document when the first access request is triggered, so that the first browsing status data can be used to control the display of the first document in the next time of displaying the first document.

Example 2: When the “first browsing status data” comprises the document browsing position of the first document when the first access request is triggered, and the identifier to be used is the URL of the second document, the “first browsing status data” can be determined based on the document position information of the identifier to be used. The “document position information of the identifier to be used” is used to indicate the position of the identifier to be used on the first document.

It can be seen that in some application scenarios, the identifier to be used (that is, the URL of the second document) may be located in a certain paragraph of the first document. Such that the first user usually sees the identifier to be used in the first document before clicking on the identifier to be used to jump to the second document. Such that the document browsing position reached by the first document before jumping is the location of the identifier to be used in the first document. The first browsing status data can be determined based on the document location information of the identifier to be used (for example, the document location information of the identifier to be used is directly determined as the first browsing status data). Such that the first browsing status data can indicate the browsing status of the first document when the first access request is triggered.

It should be noted that the execution time of S4 is later than the execution time of S1, and the embodiment of the present application does not limit the execution time of S4.

S5: Establishing a correspondence between the first identifier and the first browsing status data.

The above-mentioned “first identifier” is used to uniquely identify the first document. The embodiment of the present application does not limit the first identifier, for example, it can be the URL of the first document.

In addition, the embodiment of the present application does not limit the representation method of the above-mentioned “correspondence between the first identifier and the first browsing status data”. For example, it can be represented in a key-value pair (for example, the key can be the URL of the first document, and the value can be the first browsing status data).

Based on the relevant contents of S4 to S5 above, it can be known that for the first document (that is, the pre-jump shared document), after the first access request is triggered on the first document, the first browsing status data can be obtained. Such that the first browsing status data can indicate the browsing status of the first document when the first access request is triggered. Then the correspondence between the first identifier and the first browsing status data can be established. Such that the correspondence is used to record the browsing status of the first document before jumping. Such that when jumping back to the first document later, the first browsing status data can be determined from the correspondence based on the document identifier (i.e., the first identifier) of the first document, so that the first browsing status data can be used to initialize the browsing status data of the first document.

Correspondingly, the embodiment of the present application also provides a possible implementation of the above S2, which may specifically comprise S21-S22.

S21: Determining whether there is a correspondence comprising the identifier to be used, to obtain a determination result to be used.

The above-mentioned “determination result to be used” is used to indicate whether there is a correspondence comprising the identifier to be used.

Based on the relevant content of S21 above, it can be known that after obtaining the identifier to be used carried by the first access request, it can be determined whether there is a correspondence comprising the identifier to be used. If it exists, it indicates that the second document has been browsed, the historical browsing status of the second document can be determined based on the “correspondence comprising the identifier to be used” firstly. If it does not exist, it indicates that the second document has not been browsed, so the top position of the second document can be directly displayed to the first user.

S22: Determining whether historical browsing status data of the second document exists based on the determination result to be used.

In the implementation of the present application, after obtaining the determination result to be used, it can be determined whether historical browsing status data of the second document exists based on the determination result to be used. The determination process may specifically comprise: if the determination result to be used indicates that the correspondence comprising the identifier to be used exists, it can be determined that the historical browsing status data of the second document exists, so the historical browsing status data of the second document can be extracted from the “correspondence comprising the identifier to be used”. However, if the determination result to be used indicates that the correspondence comprising the identifier to be used does not exist, it can be determined that the historical browsing status data of the second document does not exist.

Based on the relevant contents of S21 to S22 above, it can be known that after obtaining the identifier to be used, it is possible to first search whether there is a correspondence comprising the identifier to be used from a large number of pre-stored correspondences comprising document browsing status data. If the correspondence comprising the identifier to be used exists, it indicates that the second document has been browsed before, so the historical browsing status data of the second document can be extracted from the “correspondence comprising the identifier to be used”. However, if the correspondence comprising the identifier to be used does not exist, it indicates that the second document has never been browsed, so it can be determined that the historical browsing status data of the second document does not exist.

In fact, repeated jumps may occur between different documents. Therefore, in order to avoid the

phenomenon that one document corresponds to multiple browsing status data, the embodiment of the present application also provides another possible implementation of the above-mentioned “document display method”. In this implementation, the document display method not only comprises some or all of the above-mentioned steps (for example, S1-S3, or S1-S5), but also may comprise S6.

S6: Deleting the historical browsing status data of the second document, after the controlling of the display of the second document is completed.

The embodiment of the present application does not limit the implementation of S6. For example, it may specifically be: deleting the correspondence comprising the identifier to be used (that is, deleting the correspondence between the identifier to be used and the historical browsing status data of the second document).

It should be noted that the execution time of S6 is later than the execution time of S3.

Based on the relevant content of S6, it can be known that after the second document is restored to the browsing status presented by the second document when the second document was displayed for the last time (that is, the controlling of the display of the second document is completed), it can be determined that the historical browsing status data of the second document is no longer of use value. So the historical browsing status data of the second document can be directly deleted to avoid the historical browsing status data of the second document interfering with the next display process of the second document.

Accordingly, when jumping from the second document to other documents, the browsing status data generated during the current display process of the second document can be referred to, to re-establish the correspondence comprising the identifier to be used, so as to implement the update process for the correspondence comprising the identifier to be used. Based on this, the embodiment of the present application also provides another possible implementation of the above-mentioned “document display method”, in which the document display method not only comprises some or all of the above-mentioned steps, but also may comprise S7-S8.

S7: After receiving the second access request triggered by the first user on the second document, obtaining second browsing status data.

The above-mentioned “second access request” is used to request to jump from the second document to other documents (for example, the above-mentioned “first document” or the third document). The “third document” refers to other documents except the first document and the second document.

The above-mentioned “second access request” carries a second identifier. The second identifier is used to uniquely identify the jump-target document (for example, the above-mentioned “first document” or the third document) corresponding to the above-mentioned “second access request”.

It should be noted that the above-mentioned “second access request” is similar to the above-mentioned “first access request”.

The above-mentioned “second browsing status data” is used to describe the browsing status of the second document when the second access request is triggered. It should be noted that the relevant content of the above-mentioned “second browsing status data” is similar to the relevant content of the above-mentioned “first browsing status data”.

S8: Establishing a correspondence between the identifier to be used and the second browsing status data.

It should be noted that the implementation of S8 is similar to the implementation of S5 above.

Based on the above-mentioned relevant contents of S6 to S8, it can be known that after jumping from one document to a second document, the browsing status data (that is, the historical browsing status data of the second document) corresponding to the identifier to be used can be used first to control the display of the second document. Then the correspondence comprising the identifier to be used (that is, the correspondence between the identifier to be used and the historical browsing status data of the second document) is deleted. Lastly, when jumping from the second document to other documents, the correspondence comprising the identifier to be used can be re-established based on the browsing status data of the second document before jumping, so as to realize the update process of the correspondence comprising the identifier to be used. This allows the “correspondence comprising the identifier to be used” to always present the browsing status of the second document when the second document was displayed for the last time, which is beneficial to improving the effect of the document sharing.

In fact, in some cases, the second document may never have been browsed. Based on this, the embodiment of the present application also provides another possible implementation of the above-mentioned “document display method”, in which the document display method not only comprises some or all of the above-mentioned steps, but also may further comprise S9.

S9: If it is determined that the historical browsing status data of the second document does not exist, displaying the second document to the first user based on the identifier to be used.

It can be seen that after determining that the historical browsing status data of the second document does not exist (for example, determining that the correspondence comprising the identifier to be used does not exist), it can be determined that the second document has never been browsed. Thus it can be determined that the second document is browsed for the first time, so the second document can be directly displayed to the first user based on the identifier to be used and the conventional document web page rendering method. It should be noted that the above-mentioned “conventional document web page rendering method” can be preset. For example, the “conventional document web page rendering method” can be used to directly display the top of a document to the user.

In fact, in order to better achieve the follow-up effect, the document browsing status of the sharee in the follow-up status should always be consistent with the document browsing status of the main sharer. Based on this, the embodiment of the present application also provides another possible implementation of the above-mentioned “document display method”. In this implementation, the document display method not only comprises some or all of the above steps, but may also comprise S11.

S11: If the first user meets the preset user condition, based on the above-mentioned “process of controlling the display of the second document”, displaying the second document to the second user when it is determined that the second user meets the follow-up reading condition.

The above-mentioned “preset user condition” refers to a condition met by the main sharer. The embodiment of the present application does not limit the method of obtaining the “preset user condition”. For example, the “preset user condition” can be set in advance.

The above-mentioned “follow-up reading condition” refers to a condition met by the sharee in a follow-up status. The embodiment of the present application does not limit the method of obtaining the “follow-up reading condition”. For example, the “follow-up reading condition” can be set in advance.

The above-mentioned “second user” is used to indicate the sharee who is in the follow-up status. The embodiment of the present application does not limit the determination method of the “second user”. For example, the “second user” can be determined based on the document sharing scope (for example, each person in the follow-up status in the document sharing scope can be determined as the second user).

The above-mentioned “document sharing scope” is used to describe a viewer of a shared document. The embodiment of the present application does not limit the determination process of the “document sharing scope”. For example, for a video conference, the “document sharing scope” can be determined based on the current participants (for example, all current participants except the main sharer can be gathered to obtain the document sharing scope). The above-mentioned “current participants” refer to real-time participants in the video conference.

The above “process of controlling of the display of the second document” refers to the process of controlling of the display of the second document to the first user.

It should be noted that the embodiment of the present application does not limit the implementation of S11. For example, any existing or future document sharing follow-up solution may be used for implementation.

Based on the relevant content of S11 above, it can be seen that after the main sharer triggers the first access request on the first document, in order to better achieve the follow effect, the display of the second document corresponding to the main sharer and the second document corresponding to each sharee in the follow-up status may be controlled based on the historical browsing status data of the second document. The main sharer and all sharees in the follow-up status can see the second document restored to the previous browsing status. This will help improve the effect of document sharing.

In order to better understand the above-mentioned “document display method”, the following will be explained in more detail by using different execution subjects.

The document display method applied to the first interaction module provided by the embodiment of the present application comprises steps 11 to 14.

Step 11: Receiving a first access request triggered by the first user on the first document by the first interaction module. The first access request carries an identifier to be used, and the identifier to be used is used to identify the second document.

The above-mentioned “first interaction module” refers to a module capable of interacting with the first user. The embodiment of the present application does not limit the “first interaction module”, for example, it may be a Video Conference (VC) module capable of interacting with the first user.

It should be noted that the embodiment of the present application does not limit the above-mentioned “VC module capable of interacting with the first user”. For example, it may be a VC module deployed on the terminal device used by the first user.

Based on the relevant content of the above step 11, it can be known that for the first user who is browsing the first document, after the first user triggers the first access request on the first document with the first interaction module, the first interaction module can receive the first access request. The first interaction module can extract the identifier to be used from the first access request, such that the first interaction module can subsequently use the identifier to be used to achieve the purpose of switching from the first document to the second document for display.

Step 12: The first interaction module sends the identifier to be used to the first processing module, and sends a historical browsing status data of the second document to the first processing module after obtaining the historical browsing status data of the second document. Such that the first processing module controls the display of the second document based on the identifier to be used and the historical browsing status data of the second document.

In the embodiment of the present application, for the first interaction module that obtains the identifier to be used, the first interaction module can send the identifier to be used and the historical browsing status data of the second document to the first processing module. Such that the first processing module can control the display of the second document based on the identifier to be used and the historical browsing status data of the second document. Such that the second document can be displayed based on the browsing status recorded by the historical browsing status data (for example, status information such as which page is browsed to). Such that the second document being displayed can be restored to the browsing status presented by the second document when the second document was displayed for the last time. This can effectively overcome an adverse effect caused by document jump, thereby improving the effect of document sharing.

It should be noted that the relevant content of the above-mentioned “first processing module” is shown below.

It should also be noted that some relevant contents involved in step 11 and step 12 can be referred to S1 to S3 above.

Based on the relevant content of the above steps 11 to 12, it can be known that for the first interaction module, the user can use the first interaction module to implement document jump. Such that after the jump, the document can be restored to the previous presentation. This can effectively overcome the adverse effect caused by document jump, thereby improving the user experience in sharing.

In a possible implementation, the embodiment of the present application also provides a possible sending method of the above-mentioned “identifier to be used”, which may specifically comprise steps 21 to 22.

Step 21: The first interaction module generates a document jump instruction based on the identifier to be used, such that the document jump instruction carries the identifier to be used.

The above-mentioned “document jump instruction” refers to a control instruction that jumps to the second document for display. And the “document jump instruction” comprises an identifier to be used.

Step 22: The first interaction module sends the document jump instruction to the first processing module, such that the first processing module displays the second document to the first user based on the identifier to be used carried in the document jump instruction.

Based on the relevant contents of the above steps 21 to 22, it can be known that for the first interaction module, after the first interaction module extracts the identifier to be used from the first access request, the first interaction module can first generate a document jump instruction based on the identifier to be used. Such that the document jump instruction is used to indicate a jump to the second document. The first interaction module then sends the document jump instruction to the first processing module, such that the first processing module can know control information for jumping to the second document for display from the document jump instruction. Such that the first processing module can open the second document based on the identifier to be used carried by the document jump instruction, in order to switch the object displayed by the first processing module from the first document to the second document.

In a possible implementation, the embodiment of the present application also provides a possible timing for sending the above-mentioned “historical browsing status data of the second document”, which may specifically comprise: after the first interaction module obtains the status data query request sent by the first processing module, the first interaction module sends the historical browsing status data of the second document to the first processing module, such that the first processing module controls the browsing status of the second document based on the historical browsing status data.

The above-mentioned “status data query request” is used to request the first interaction module to provide historical browsing status data. And the relevant content of the above-mentioned “status data query request” can refer to step 312 below.

It can be seen that for the first interaction module, after the first interaction module extracts the identifier to be used from the first access request, the first interaction module can first send the identifier to be used to the first processing module. Such that the first processing module can generate and send the status data query request based on the identifier to be used. Such that after the first interaction module receives the status data query request, the first interaction module can directly feedback the historical browsing status data of the second document to the first processing module. Such that the first processing module can subsequently control the browsing status of the second document based on the historical browsing status data of the second document. Such that the second document can be restored to the browsing status presented by the second document when the second document was displayed for the last time.

In fact, the first interaction module only records the browsing status data of documents that have been browsed, such that there is no browsing status data of those documents which have not browsed in the first interaction module. Based on this, the embodiment of the present application also provides another possible implementation of the above-mentioned “document display method applied to the first interaction module”. This method not only comprises all or part of the above steps, but may also comprise step 13.

Step 13: After the first interaction module obtains the status data query request sent by the first processing module, if the first interaction module determines that the historical browsing status data of the second document does not exist, the first interaction module sends the preset information to the first processing module. The above-mentioned “preset information” is used to indicate that the historical browsing status data of the second document does not exist in the first interaction module.

It can be seen that for the first interaction module, after the first interaction module receives the status data query request sent by the first processing module, if the first interaction module determines that the historical browsing status data of the second document does not exist, then the first interaction module can determine that the first user has never browsed the second document. So the first interaction module can directly send the preset information, which is set previously, to the first processing module. Such that the first processing module can learn from the preset information that the historical browsing status data of the second document does not exist in the first interaction module. Such that the first processing module can controls the display of the second document based on the normal document display process.

In fact, in order to better search the historical browsing status data of a document from the first interaction module, a correspondence between the document identifier of pre-jump document and the current browsing status data of pre-jump document can be established during each document jump. Such that in the next display process of the “pre-jump document”, a rendering initial value of the browsing status of the “pre-jump document” can be determined based on this correspondence. Based on this, the embodiment of the present application also provides another possible implementation of the above-mentioned “document display method applied to the first interaction module”, which not only comprises all or part of the above-mentioned steps, but also may comprise steps 14-15.

Step 14: The first interaction module obtains the first browsing status data sent by the first processing module. The first browsing status data is used to describe the browsing status of the first document when the first access request is triggered.

Step 15: The first interaction module establishes the correspondence between the first identifier and the first browsing status data. The first identifier is used to identify the first document.

It should be noted that some relevant contents involved in steps 14 to 15 can be refer to S4 to S5 above.

Based on the relevant content of the steps 14 to 15 above, it can be known that for the first interaction module, after the first interaction module extracts the identifier to be used from the first access request, the first interaction module can first send the identifier to be used to the first processing module. Such that the first processing module can feedback the first browsing status data to the first interaction module based on the identifier to be used. This allows the first interaction module to establish a correspondence between the first identifier and the first browsing status data after receiving the first browsing status data. Such that the correspondence is used to record the browsing status of the first document before jumping. Such that when jumping back to the first document, the first interaction module can determine the first browsing status data from the correspondence based on the document identifier of the first document (i.e., the first identifier). So that the first browsing status data can be used to initialize the browsing status data of the first document.

Correspondingly, the embodiment of the present application also provides a possible method of obtaining the “historical browsing status data of the second document” in step 12, which may specifically comprise: the first interaction module determines the historical browsing status data of the second document from the “correspondence comprising the identifier to be used” after obtaining the correspondence comprising the identifier to be used.

It can be seen that for the first interaction module, after the first interaction module receives the status data query request sent by the first processing module, the first interaction module can first search whether there is a correspondence comprising the identifier to be used from a large number of pre-stored correspondences comprising document browsing status data. If the correspondence comprising the identifier to be used exists, it indicates that the second document has been browsed before. Therefore, the historical browsing status data of the second document can be extracted from the “correspondence comprising the identifier to be used”. However, if the “correspondence comprising the identifier to be used” does not exist, it indicates that the second document has not been browsed before, so it can be determined that the historical browsing status data of the second document does not exist.

In fact, repeated jumps may occur between different documents. Therefore, in order to avoid the phenomenon that one document corresponds to multiple browsing status data, the embodiment of the present application also provides another possible implementation of the above-mentioned “document display method applied to the first interaction module”. The method not only comprises all or part of the above steps, but may also comprise step 16.

Step 16: After the first interaction module obtains the control complete information sent by the first processing module, the first interaction module deletes the historical browsing status data of the second document.

The above-mentioned “control complete information” is used to indicate that the first processing module has completed the controlling of the display of the second document. And for the obtaining process of the “control complete information”, please refer to the relevant content below.

It should be noted that some relevant content involved in step 16 can be found in S6 above.

Based on the relevant content of the above step 16, it can be known that for the first interaction module, after the first interaction module receives the control complete information sent by the first processing module, the first interaction module can learn from the control complete information that the second document is in a browsing status. Such that the first interaction module can determine that the historical browsing status data of the second document has no reference value. Therefore, in order to avoid the historical browsing status data of the second document interfering with the subsequent jump process of the second document, the historical browsing status data of the second document can be directly deleted (for example, the “correspondence comprising the identifier to be used” can be directly deleted).

Accordingly, when the first interaction module responds to a user operation for jumping from the second document to other documents, the correspondence comprising the identifier to be used is re-established, by referring to the browsing status data generated during the current display process of the second document. This allows the implement of the update process for the correspondence comprising the identifier to be used. Based on this, the embodiment of the present application also provides another possible implementation of the above-mentioned “document display method applied to the first interaction module”, in which the method not only comprises some or all of the above-mentioned steps, but also may comprise steps 17-18.

Step 17: After the first user receives the second access request triggered on the second document, the first interaction module obtains the second browsing status data sent by the first processing module.

It should be noted that the process of the first interaction module acquiring the second browsing status data is similar to the above “the process of the first interaction module acquiring the first browsing status data”.

Step 18: The first interaction module establishes a correspondence between the identifier to be used and the second browsing status data.

It should be noted that some relevant contents involved in step 17 and step 18 can be found in S7 and S8 above.

Based on the relevant contents of the above steps 17 to 18, it can be known that for the first interaction module, after the first interaction module receives the second access request triggered by the first user on the second document, the first interaction module may first generate a document switch instruction based on the second identifier carried by the second access request (that is, the document identifier of the jump-target document corresponding to the second access request). And then the first interaction module sends the document switch instruction to the first processing module. Such that after receiving the document switch instruction, the first processing module can feedback the second browsing status data to the first interaction module. Such that the second browsing status data can indicate the browsing status of the second document when the second access request is triggered. Such that after the first interaction module receives the second browsing status data, the first interaction module can establish the correspondence between the identifier to be used and the second browsing status data. This can realize the process of re-establishing the correspondence comprising the identifier to be used, so that the “correspondence comprising the identifier to be used” can always accurately represent the browsing status of the second document when the second document was displayed for the last time. This is beneficial for improving the effect of document sharing.

It should be noted that the above-mentioned “document switch instruction” refers to a control instruction for jumping from the second document to other documents (for example, the first document or the third document, etc.) for display. And the “document switch instruction” comprises the second identifier. It should be noted that the above-mentioned “document switch instruction” is similar to the above-mentioned “document jump instruction”.

In fact, in order to better achieve the follow effect, the document browsing status of the sharee in the follow-up status should always be consistent with the document browsing status of the main sharer. Based on this, the embodiment of the present application also provides another possible implementation of the above-mentioned “document display method applied to the first interaction module”. In this implementation, the method not only comprises some or all of the above steps, but also may comprise step 19.

Step 19: If the first interaction module determines that the first user meets the preset user condition, the first interaction module sends a document follow-up instruction to the second interaction module when the first interaction module determines that the second user meets the follow-up reading condition. Such that the second interaction module controls the second processing module to follow up a process of controlling of the display of the second document by the first processing module.

The above-mentioned “second interaction module” refers to a module capable of interacting with the second user. And the “second interaction module” can perform data communication with the above-mentioned “first interaction module”.

In addition, the embodiment of the present application does not limit the above-mentioned “second interaction module”, for example, it can be a VC module that can interact with the second user. It should be noted that the embodiment of the present application does not limit the above-mentioned “VC module capable of interacting with the second user”, for example, it can be a VC module deployed on the terminal device used by the second user.

The above-mentioned “second processing module” refers to a document processing module that can perform data communication with the second interaction module. And the embodiment of the present application does not limit the “second processing module”. For example, it may be a Creation and Content Management (CCM) module that can perform data communication with the second interaction module.

It should be noted that the embodiments of the present application are not limited to the above-mentioned “CCM module capable of performing data communication with the second interaction module”. For example, it may be a CCM module deployed on the terminal device used by the second user.

The above-mentioned “document follow-up instruction” is used to control the second interaction module to follow up the first interaction module for controlling of the document sharing. And the embodiment of the present application does not limit the “document follow-up instruction”. For example, any existing or future document sharing follow-up instruction can be used for implementation.

It should be noted that some relevant content involved in step 19 can be found in S11 above.

Based on the relevant content of step 19 above, it can be known that for the first interaction module that can interact with the main sharer, when the first interaction module receives the first access request triggered by the main sharer on the first document, the first interaction module can send the document follow-up instruction to the second interaction module corresponding to each sharee in the follow-up status. Such that these second interaction modules can control the second processing module to follow up a process of controlling of the display of the second document by the first processing module. Such that the main sharer and all sharee in the follow-up status can see the second document restored to the previous browsing status, thereby improving the effect of document sharing.

The document display method applied to the first processing module provided by the embodiment of the present application comprises step 31.

Step 31: When the first processing module is displaying the first document, the first processing module controls the display of the second document based on the identifier to be used and the historical browsing status data of the second document sent by the first interaction module. Such that the first processing module starts to display the second document. The identifier to be used is used to identify the second document.

The above-mentioned “first processing module” refers to a document processing module that can perform data communication with the first interaction module. And the embodiments of the present application do not limit the “first processing module”, for example, it can be a CCM module that can perform data communication with the first interaction module.

It should be noted that the embodiment of the present application is not limited to the above-mentioned “CCM module capable of communicating data with the first interaction module”. For example, it may be a CCM module deployed on the terminal device used by the first user.

It should also be noted that some relevant contents involved in step 31 can be found in S1-S3 above. In addition, the relevant contents of the “first interaction module” can be found in the above.

Based on the relevant content of the above step 31, it can be known that for the first processing module that is displaying the first document, after the first processing module receives the identifier to be used and the historical browsing status data of the second document sent by the first interaction module, the first processing module can control the display of the second document based on the identifier to be used and the historical browsing status data of the second document. Such that the second document can be displayed based on the browsing status (for example, status information such as which page is browsed to) recorded by the historical browsing status data. Such that the second document being displayed can be restored to the browsing status presented by the second document when the second document was displayed for the last time, which can effectively overcome the adverse effects caused by document jump, thereby improving the effect of document sharing.

In a possible implementation, the embodiment of the present application further provides a process of controlling the display of the second document by the first processing module (that is, a possible implementation of step 31), which may specifically comprise steps 311 to 315.

Step 311: After the first processing module receives the document jump instruction sent by the first interaction module, the first processing module displays the second document to the first user based on the identifier to be used carried in the document jump instruction.

In the embodiment of the present application, for a first processing module that is displaying the first document, after the first processing module receives a document jump instruction sent by the first interaction module, the first processing module can open the second document based on the identifier to be used carried by the document jump instruction. Such that the object displayed by the first processing module can be switched from the first document to the second document.

Step 312: When the first processing module determines that the second document is in the display status, the first processing module generates a status data query request based on the identifier to be used. The status data query request is used to request the first interaction module to provide the historical browsing status data of the second document.

In the embodiment of the present application, for the first processing module, after the first processing module determines that the second document has been opened, the first processing module can first generate a status data query request based on the identifier to be used. Such that the status data query request carries the identifier to be used, and the historical browsing status data of the second document can be requested from the first interaction module by using the status data query request.

Step 313: The first processing module sends the status data query request to the first interaction module.

In the embodiment of the present application, for the first processing module, after the first processing module obtains the status data query request, the first processing module can send the status data query request to the first interaction module. Such that the first interaction module can learn that the first processing module needs to use the historical browsing status data of the second document, based on the status data query request.

Step 314: The first processing module obtains the status data query result fed back by the first interaction module with respect to the status data query request.

The above-mentioned “status data query result” refers to the feedback information provided by the first interaction module for the status data query request. Such that the “status data query result” can be used to indicate whether historical browsing status data of the second document exists in the first interaction module.

In addition, the embodiments of the present application do not limit the above-mentioned “status data query result”. For example, if the historical browsing status data of the second document exists in the first interaction module, the “status data query result” may comprise the historical browsing status data of the second document. However, if the historical browsing status data of the second document does not exist in the first interaction module, the “status data query result” may comprise preset information. The preset information is used to indicate that the historical browsing status data does not exist in the first interaction module.

Step 315: If the status data query result carries the historical browsing status data of the second document, the first processing module controls the browsing status of the second document based on the historical browsing status data.

In the embodiment of the present application, for the first processing module, after the first processing module obtains the status data query result fed back by the first interaction module, if the status data query result carries the historical browsing status of the second document data, it can be indicated that the historical browsing status data of the second document exists in the first interaction module. And thus it can be indicated that the second document has been browsed before. Therefore, the first processing module can control the browsing status of the second document based on the historical browsing status data of the second document carried by the status data query result. Such that the second document can be restored to the browsing status presented by the second document when the second document was displayed for the last time. Such that the first user can continue reading, on the first processing module, based on the previous browsing status of the second document, which is beneficial to improving the user experience in document sharing.

Based on the relevant contents of the above steps 311 to 315, it can be known that for the first processing module that is displaying the first document, the first processing module can use multiple information interaction processes with the first interaction module to switch the object displayed by the first processing module from the first document to the second document, and enable the second document to be restored to the browsing status presented by the second document when the second document was displayed for the last time, which is beneficial to improving the effect of document sharing.

In fact, the first interaction module only records the browsing status data of documents that have been browsed before, such that the browsing status data of documents that have not been browsed yet does not exist in the first interaction module. Based on this, the embodiment of the present application also provides another possible implementation of the above-mentioned “document display method applied to the first processing module”, which not only comprises all or part of the above steps, but also may further comprise step 316.

Step 316: If the status data query result indicates that the historical browsing status data of the second document does not exist in the first interaction module, the first processing module controls the display of the second document based on the preset browsing status data.

The above-mentioned “preset browsing status data” refers to a preset initial value of the document browsing data. And the embodiment of the present application does not limit the “preset browsing status data”. For example, it can be implemented using any existing or future initial value of the document browsing data (for example, displaying the top position of the document, etc.).

Based on the relevant content of the above step 316, it can be known that for the first processing module, after the first processing module obtains the status data query result fed back by the first interaction module, if the status data query result indicates that the historical browsing status data of the second document does not exist in the first interaction module, it can be determined that the second document has not been browsed. Therefore, the first processing module can control the display of the second document based on the preset browsing status data (such as conventional browsing status rendering data). Such that the second document can be displayed in the first processing module based on the status required for the first display of the document, so that the first user can start browsing the second document from scratch.

In fact, in order to better search the historical browsing status data of a document, during each document jump, the correspondence between the document identifier of the pre-jump document and the current browsing status data of the pre-jump document can be established. Such that during the next display of the “pre-jump document”, the rendering initial value of the browsing status of the “pre-jump document” can be determined based on the correspondence. The embodiment of the present application also provides another possible implementation of the above-mentioned “document display method applied to the first processing module”. The method not only comprises all or part of the above steps, but may also comprise step 317.

Step 317: After the first processing module receives the document jump instruction sent by the first interaction module, the first processing module sends the first browsing status data to the first interaction module, such that the first interaction module establishes the correspondence between the first identifier and the first browsing status data.

The above-mentioned “first browsing status data” is used to describe the browsing status of the first document when the first processing module receives the document jump instruction sent by the first interaction module.

It should be noted that some relevant contents involved in step 317 can be found in the above steps 14 and 15.

In addition, the embodiment of the present application does not limit the method of obtaining the above-mentioned “first browsing status data”. For example, it can be implemented by adopting the method of obtaining the “first browsing status data” shown in S4. In another example, the above-mentioned “first browsing status data” can be determined based on the historical browsing operation by the first user on the first document, and the historical browsing operation is used to indicate the document browsing operation triggered by the first user on the first document which is before the first processing module receives the document jump instruction sent by the first interaction module.

In fact, repeated jumps may occur between different documents. Therefore, in order to avoid the phenomenon that one document corresponds to multiple browsing status data, the embodiment of the present application also provides another possible implementation of the above-mentioned “document display method applied to the first processing module”, which not only comprises all or part of the above steps, but also may comprise steps 32-33.

Step 32: After the first processing module determines that the controlling of the display of the second document is completed, the first processing module generates control complete information based on the identifier to be used. Such that the control complete information can indicate that the first processing module has completed the controlling of the display of the second document.

Step 33: The first processing module sends control complete information to the first interaction module, such that the first interaction module deletes the historical browsing status data of the second document.

Based on the relevant content of the above steps 32 to 33, it can be known that for the first processing module, after the first processing module determines that the controlling of the display of the second document is completed, the first processing module can first generate the control complete information based on the identifier to be used. Such that the control complete information carries the identifier to be used, and the control complete information can indicate that the first processing module has completed the controlling of the display of the second document. And then the first processing module sends the completion information to the first interaction module, such that the first interaction module can learn from the control complete information that the first processing module has completed the controlling of the display of the second document. Such that the first interaction module can determine that the historical browsing status data of the second document has no reference value, and thus the first interaction module can directly delete the historical browsing status data of the second document, which can effectively avoid interference from the historical browsing status data of the second document on the subsequent jumping process of the second document, and thus improve the effect of document sharing.

Accordingly, when jumping from the second document to other documents, the browsing status data generated during the current display process of the second document can be referred to, to re-establish the correspondence comprising the identifier to be used, so as to implement the update process for the correspondence comprising the identifier to be used. Based on this, the embodiment of the present application also provides another possible implementation of the above-mentioned “document display method applied to the first processing module”, in which the method not only comprises some or all of the above steps, but also may comprise step 34.

Step 34: After the first processing module receives the document switch instruction sent by the first interaction module, the first processing module sends the second browsing status data to the first interaction module, such that the first interaction module establishes a correspondence between the identifier to be used and the second browsing status data. The second browsing status data is used to describe the browsing status of the second document when the first processing module receives the document switch instruction sent by the first interaction module.

It should be noted that for some relevant content involved in step 34, please refer to above steps 17 to 18.

Based on the relevant content of step 34 above, it can be known that for the second document, after the first interaction module receives the second access request triggered by the first user on the second document, the first interaction module may first generate a document switch instruction based on the second identifier carried by the second access request. And then the first interaction module sends the document switch instruction to the first processing module, such that after the first processing module receives the document switch instruction, the second browsing status data is fed back to the first interaction module. Such that the first interaction module establishes a correspondence between the identifier to be used and the second browsing status data. This can realize the process of re-establishing the correspondence comprising the identifier to be used, so that the “correspondence comprising the identifier to be used” can always accurately represent the browsing status of the second document when the second document was displayed for the last time. This is beneficial for improving the effect of document sharing.

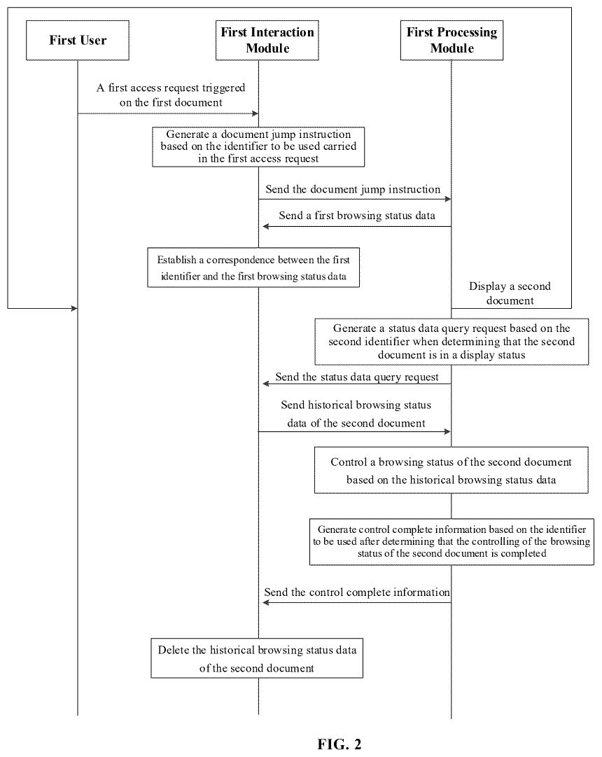

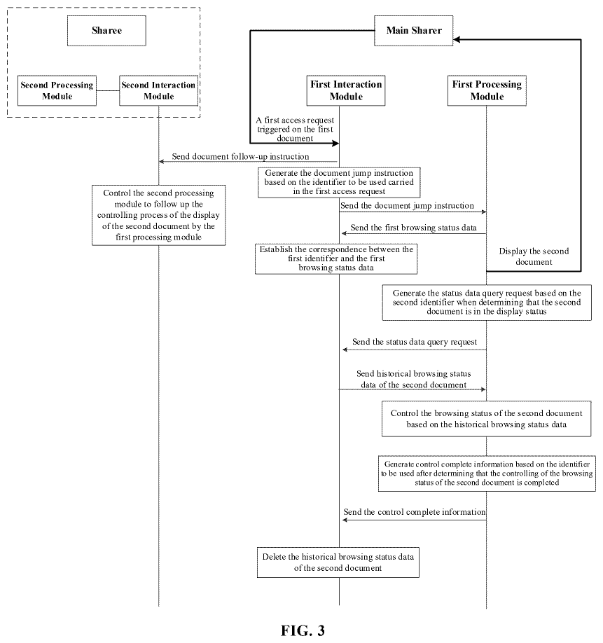

In order to better understand the above-mentioned “document display method”, the following describes the information interaction process shown in FIG. 2 and FIG. 3 as an example.

As an example, as shown in FIG. 2, the document display method provided by the embodiment of the present application may comprise steps 41 to 55.

Step 41: The first interaction module receives the first access request triggered by the first user on the first document. The “first document” is used to indicate the document before jumping. “First access request” is used to request to jump from the first document to the second document. The “second document” is used to indicate the document after jumping.

It should be noted that for the relevant content of step 41, please refer to step 11 above.

Step 42: The first interaction module generates a document jump instruction based on the identifier to be used carried in the first access request. The identifier to be used is used to identify the second document.

It should be noted that for the relevant content of step 41, please refer to step 21 above.

Step 43: The first interaction module sends the document jump instruction to the first processing module.

Step 44: The first processing module sends the first browsing status data to the first interaction module, such that the first interaction module establishes a correspondence between the first identifier and the first browsing status data. The first browsing status data is used to describe the browsing status of the first document when the first processing module receives the document jump instruction sent by the first interaction module. The first identifier is used to identify the first document.

Step 45: The first processing module displays the second document to the first user based on the identifier to be used carried in the document jump instruction.

It should be noted that for the relevant content of step 45, please refer to step 311 above.

Step 46: When the first processing module determines that the second document is in the display status, the first processing module generates a status data query request based on the identifier to be used. The status data query request is used to request the first interaction module to provide historical browsing status data of the second document.

It should be noted that for the relevant content of step 46, please refer to step 312 above.

Step 47: The first processing module sends the status data query request to the first interaction module.

It should be noted that for the relevant content of step 47, please refer to step 313 above.

Step 48: The first interaction module determines whether historical browsing status data of the second document exists based on the identifier to be used carried in the status data query request, to obtain the status data query result. The status data query result is used to indicate whether historical browsing status data of the second document exists in the first interaction module (for example, whether there is a correspondence comprising the identifier to be used stored in the first interaction module).

It should be noted that the embodiment of the present application does not limit the implementation of step 48. For example, it can be implemented using any implementation of S2.

Step 49: The first interaction module sends the status data query result to the first processing module.

Step 50: The first processing module determines whether historical browsing status data of the second document exists in the first interaction module based on the status data query result. If so, steps 52 to 55 is performed; if not, step 51 is performed.

Step 51: The first processing module controls the display of the second document based on preset browsing status data.

It should be noted that for the relevant content of step 51, please refer to the above step 316.

Step 52: The first processing module controls the browsing status of the second document based on the historical browsing status data of the second document carried in the status data query result.

It should be noted that for the relevant content of step 52, please refer to the above step 315.

Step 53: After the first processing module determines that the controlling of display of the second document is completed, the first processing module generates control complete information based on the identifier to be used. The control complete information is used to indicate that the first processing module has completed the controlling of display of the second document.

It should be noted that for the relevant content of step 53, please refer to the above step 32.

Step 54: The first processing module sends control complete information to the first interaction module.

Step 55: After the first interaction module obtains the control complete information sent by the first processing module, the first interaction module deletes the historical browsing status data of the second document (for example, deletes the correspondence comprising the identifier to be used stored in the first interaction module).

Based on the relevant contents of the above steps 41 to 55, it can be known that the embodiment of the present application can realize the jumping process between different documents by using multiple information interaction processes between the first interaction module and the first processing module. This ensures that after the jump the document is restored to the previous browsing status presented at last display, which is beneficial to improving the effect of document sharing.

It should be noted that the first user mentioned above can be either a main sharer or a sharee in a free reading status.

In addition, when the first user is the main sharer as shown in FIG. 3, the document display method provided in the embodiment of the present application comprises not only steps 41 to 55, but also step 56.

Step 56: When the first interaction module determines that the second user meets the follow-up reading condition, the first interaction module sends a document follow-up instruction to the second interaction module. Such that the second interaction module controls the second processing module to follow up the process of controlling of the display of the second document by the first processing module.

It should be noted that for the relevant content of step 56, please refer to the relevant content of step 19 above.

Based on the relevant content of the above step 56, it can be known that the embodiment of the present application can use the information interaction process between the first interaction module and the second interaction module to realize that the document processing module corresponding to the sharee in the follow-up status can follow the process of controlling of the display of the second document by the first processing module. This ensures that the second document seen by the main sharer and the second document seen by each sharee in the follow-up status are in the same browsing status, which is beneficial to improving the effect of document sharing.

In addition, the usage scenario of the document display method provided by the embodiment of the present application can be: jumping to other document B through a link in document A, and then jumping back to document A through a backward operation or a link in document A to locate a reading position of document A before entering into document B. Similarly, the document display method provided by the embodiment of the present application is also suitable for an application scenario for multi-level jump. For example, after clicking a link of document A to enter into document B, it is possible to choose to go back to document A to locate the reading position of document A before entering into document B. When entering into document B again from document A, the previous reading position of document B is located. Then after entering into document C from document B, and going back to document B, the previous reading position of document B before entering into document C is located. After going back to document A, the previous reading position of document A is located.

In addition, in order to avoid interference between sharing processes of the different document, the first interaction module can clear all correspondences comprising browsing status data after the current sharing is completed. Such that when a participant in the video conference re-initiates document sharing, the participant will not be affected by the previous document sharing process. This can effectively avoid interference between sharing processes of the different document, thereby helping to improve the effect of document sharing.

Based on the document display method provided by the above method embodiment, the embodiment of the present application also provides a document display device, which is explained and illustrated below in conjunction with the accompanying drawings.

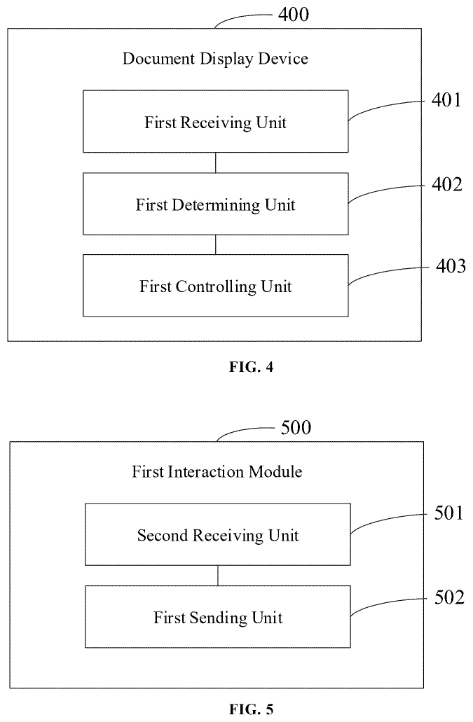

FIG. 4 is a schematic diagram of the structure of a document display device provided in the embodiment of the present application.

The document display device 400 provided in the embodiment of the present application comprises:
a first receiving unit 401 configured to receive the first access request triggered by the first user on the first document, wherein the first access request carries an identifier to be used, and the identifier to be used is used to identify the second document;
a first determining unit 402 configured to determine whether historical browsing status data of the second document exists based on the identifier to be used;
a first controlling unit 403 configured to control the display of the second document based on the identifier to be used and the historical browsing status data, if it is determined that the historical browsing status data exists.

In a possible implementation, the first controlling unit 403 is specifically configured to display the second document to the first user based on the identifier to be used; and configured to control the browsing status of the second document based on the historical browsing status data, after determining that the second document is in the display status.

In a possible implementation, the document display device 400 further comprises:
a first obtaining unit configured to obtain first browsing status data after receiving the first access request triggered by the first user on the first document, wherein the first browsing status data is used to describe a browsing status of the first document when the first access request is triggered;
a first establishing unit configured to establish a correspondence between the first identifier and the first browsing status data, wherein the first identifier is used to identify the first document.
The first determining unit 402 comprises:
a first determining subunit configured to determine whether there is a correspondence comprising the identifier to be used, to obtain a determination result to be used;
a first determining subunit configured to determine whether historical browsing status data of the second document exists based on the determination result to be used.

In a possible implementation, the first determining subunit is specifically configured to extract the historical browsing status data of the second document from the correspondence comprising the identifier to be used if the determination result to be used indicates that the correspondence comprising the identifier to be used exists; and configured to determine that the historical browsing status data of the second document does not exist if the determination result to be used indicates that the correspondence comprising the identifier to be used does not exist.

In a possible implementation, the document display device 400 further comprises:
a first deleting unit configured to delete the historical browsing status data of the second document after controlling the display of the second document based on the identifier to be used and the historical browsing status data.

In a possible implementation, the document display device 400 further comprises:
a second obtaining unit configured to obtain second browsing status data after receiving the second access request triggered by the first user on the second document, wherein the second browsing status data is used to describe the browsing status of the second document when the second access request is triggered;
a second building unit configured to build a correspondence between the identifier to be used and the second browsing status data.

In a possible implementation, the document display device 400 further comprises:
a first display unit configured to display the second document to the first user based on the identifier to be used if it is determined that the historical browsing status data does not exist.

In a possible implementation, the document display device 400 further comprises:
a second display unit configured to display the second document to the second user based on the process of controlling of the display of the second document when it is determined that the second user meets the follow-up reading condition, if the first user meets the preset user condition.

In a possible implementation, the second user is determined based on a document sharing scope.

In a possible implementation, the document sharing scope is determined based on current conference participants.

Based on the relevant content of the above document display device 400, it can be known that for the document display device 400, after receiving the first access request triggered by the first user on the first document, whether historical browsing status data of the second document exists is determined based on the identifier to be used carried by the first access request for uniquely identifying the second document. Such that when it is determined that the historical browsing status data of the second document exists, a display of the second document is controlled based on the identifier to be used and the historical browsing status data of the second document. Such that the second document can be displayed based on a browsing status (for example, status information such as which page to browse to) recorded by the historical browsing status data. The second document being displayed can be restored to the browsing status presented by the second document when the second document was displayed for the last time. This can effectively overcome the problems caused by document jump, thereby improving the effect of document sharing and enhancing the user experience in document sharing

Based on the relevant contents of the above-mentioned document display method, the embodiment of the present application also provides a first interaction module, which is explained and illustrated below in conjunction with the accompanying drawings.

FIG. 5 is a schematic diagram of the structure of a first interaction module provided in the embodiment of the present application.

The first interaction module 500 provided in the embodiment of the present application comprises:
a second receiving unit 501 configured to receive a first access request triggered by a first user on a first document, wherein the first access request carries an identifier to be used, and the identifier to be used is used to identify a second document;
a first sending unit 502 configured to send the identifier to be used to the first processing module, and send the historical browsing status data to the first processing module after obtaining historical browsing status data of the second document, such that the first processing module controls the display of the second document based on the identifier to be used and the historical browsing status data, wherein the historical browsing status data is obtained based on the identifier to be used.

In a possible implementation, the first interaction module 500 further comprises:
a first generation unit configured to generate a document jump instruction based on the identifier to be used.

The first sending unit 502 comprises:
a first sending subunit configured to send the document jump instruction to the first processing module, such that the first processing module displays the second document to the first user based on the identifier to be used carried by the document jump instruction;
a second sending subunit configured to send the historical browsing status data to the first processing module after obtaining the status data query request sent by the first processing module, such that the first processing module controls the browsing status of the second document based on the historical browsing status data; wherein the status data query request is used to request the first interaction module to provide the historical browsing status data.

In a possible implementation, the first interaction module 500 further comprises:
a second sending unit configured to, after obtaining the status data query request sent by the first processing module, send preset information to the first processing module if it is determined that the historical browsing status data does not exist. The preset information is used to indicate that the historical browsing status data does not exist in the first interaction module.

In a possible implementation, the first interaction module 500 further comprises:
a third obtaining unit configured to obtain first browsing status data sent by the first processing module after sending the document jump instruction to the first processing module, wherein the first browsing status data is used to describe the browsing status of the first document when the first access request is triggered;
a third establishing unit configured to establish a correspondence between the first identifier and the first browsing status data, wherein the first identifier is used to identify the first document.

The process of obtaining the historical browsing status data comprises: after obtaining the correspondence comprising the identifier to be used, determining the historical browsing status data of the second document from the correspondence comprising the identifier to be used.

In a possible implementation, the first interaction module 500 further comprises:
a second deleting unit configured to delete the historical browsing status data of the second document after obtaining the control complete information sent by the first processing module. Wherein the control complete information is used to indicate the first processing module has completed the controlling of the display of the second document.

In a possible implementation, the first interaction module 500 further comprises:
a third sending unit configured to send a document follow-up instruction to the second interaction module when it is determined that the second user meets the follow-up reading conditions, if the first user meets the preset user conditions, such that the second interaction module controls the second processing module to follow up the process of controlling of the display of the second document by the first processing module.

In a possible implementation, the second user is determined based on the document sharing scope.

In a possible implementation, the document sharing scope is determined based on current participants.

Based on the relevant content of the above-mentioned first interaction module 500, it can be known that for the first interaction module 500, the user can use the first interaction module to perform document jump processing, such that the document after jumping can be restored to the browsing status presented at the previous display. This can effectively overcome the adverse effects caused by document jump, thereby improving the user experience in sharing.

Based on the relevant contents of the above-mentioned document display method, the embodiment of the present application also provides a first processing module, which is explained and illustrated below in conjunction with the accompanying drawings.

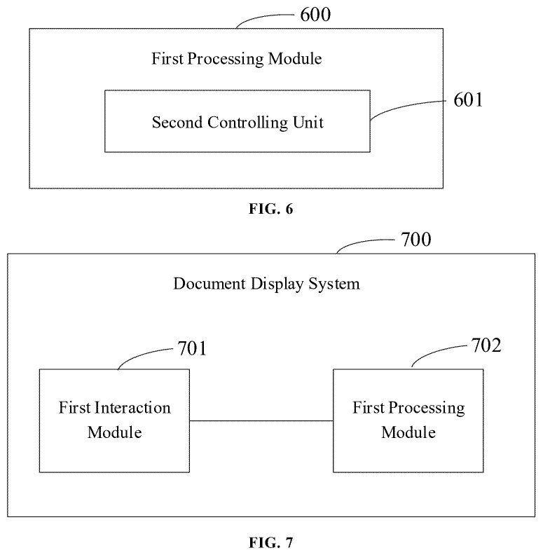

FIG. 6 is a schematic diagram of the structure of a first processing module provided in the embodiment of the present application.

The first processing module 600 provided in the embodiment of the present application comprises:
a second controlling unit 601 configured to receive the identifier to be used and the historical browsing status data of the second document sent by the first interaction module when the first processing module is displaying the first document; and to control the display of the second document based on the identifier to be used and the historical browsing status data of the second document, such that the first processing module starts to display the second document. Wherein the identifier to be used is used to identify the second document.

In a possible implementation, the second controlling unit 601 is specifically configured to, after receiving the document jump instruction sent by the first interaction module, display the second document to the first user based on the identifier to be used carried by the document jump instruction; when it is determined that the second document is in the display status, generate a status data query request based on the identifier to be used; send the status data query request to the first interaction module; obtain the status data query result fed back by the first interaction module for the status data query request; and if the status data query result carries the historical browsing status data of the second document, controlling the browsing status of the second document based on the historical browsing status data.

In a possible implementation, the first processing module 600 further comprises:

a third controlling unit configured to control the display of the second document based on a preset browsing status data, if the status data query result indicates that the historical browsing status data of the second document not exists in the first interaction module.

In a possible implementation, the first processing module 600 further comprises:
a fourth sending unit configured to send the first browsing status data to the first interaction module after receiving the document jump instruction sent by the first interaction module. Wherein the first browsing status data is used to describe the browsing status of the first document when receiving the document jump instruction sent by the first interaction module.

In a possible implementation, the first browsing status data is determined based on a historical browsing operation of the first user on the first document. The historical browsing operation is used to indicate a document browsing operation triggered by the first user on the first document before receiving a document jump instruction sent by the first interaction module.

In a possible implementation, the first browsing status data is determined based on document location information of the identifier to be used. The document location information is used to indicate a position of the identifier to be used on the first document.

In a possible implementation, the first processing module 600 further comprises:
a second generation unit configured to generate control complete information based on the identifier to be used after controlling the display of the second document based on the identifier to be used and the historical browsing status data of the second document;
a fifth sending unit configured to send the control complete information to the first interaction module, such that the first interaction module deletes the historical browsing status data of the second document.

Based on the relevant content of the first processing module 600, it can be known that for the first processing module 600, after the first processing module receives the identifier to be used and the historical browsing status data of the second document sent by the first interaction module, the first processing module can control the display of the second document based on the identifier to be used and the historical browsing status data of the second document. Such that the second document can be displayed based on a browsing status (for example, status information such as which page is browsed to) recorded by the historical browsing status data. Such that the second document being displayed can be restored to a browsing status presented by the second document when the second document was displayed for the last time. This can effectively overcome an adverse effect caused by document jump, thereby improving the effect of document.

Based on the above-mentioned related contents of the first interaction module and the first processing module, the embodiment of the present application also provides a document display system, which will be explained and described below with reference to the accompanying drawings.

FIG. 7 is a schematic diagram of the structure of the document display system provided by the embodiment of the present application.

The document display system 700 provided by the embodiment of the present application comprises any first interaction module provided by the embodiment of the present application, and any first processing module provided by the embodiment of the present application.

It should be noted that the first interaction module is configured to execute any implementation of the document display method applied to the first interaction module provided by the embodiments of the present application. In addition, the first processing module is configured to execute any implementation of the document display method applied to the first interaction module provided by the embodiment of the present application.

Based on the relevant content of the above document display system 400, it can be known that for the document display system 400, after receiving a first access request triggered by a first user on a first document, determining whether historical browsing status data of the second document exists based on the identifier to be used carried by the first access request for identifying the second document. Such that when it is determined that the historical browsing status data of the second document exists, a display of the second document is controlled based on the identifier to be used and the historical browsing status data of the second document. Such that the second document can be displayed based on a browsing status (for example, status information such as which page is browsed to) recorded by the historical browsing status data. Such that the second document being displayed can be restored to a browsing status presented by the second document when the second document was displayed for the last time. This can effectively overcome an adverse effect caused by document jump, thereby improving the effect of document sharing and enhancing the user experience in document sharing

Further, the embodiment of the present application also provides a device, which comprises a processor and a memory.

The memory is used to store computer programs.

The processor is configured to execute any implementation of the document display method provided by the embodiment of the present application based on the computer program.

Furthermore, the embodiment of the present application also provides a computer-readable storage medium for storing a computer program for performing any implementation of the document display method provided in the embodiment of the present application.

Furthermore, the embodiment of the present application also provides a computer program product that, when running on a terminal device, causes the terminal device to execute any implementation of the document display method provided in the embodiment of the present application.

It should be understood that in the present application, “at least one (item)” means one or more, and “plurality” means two or more. “And/or” is used to describe the association relationship of associated objects, indicating that three relationships may exist. For example, “A and/or B” can represent only A exists, only B exists, and both A and B exist at the same time, where A and B can be singular or plural. The character “/” generally indicates that the associated objects are in an “or” relationship. “At least one of the following” or similar expressions refers to any combination of these items, comprising any combination of single or plural items. For example, at least one of a, b or c can represent a, b, c, “a and b”, “a and c”, “b and c”, or “a and b and c”, where a, b, c can be single or multiple.

The above is only a preferred embodiment of the present application and does not limit the present application in any form. Although the present application has been disclosed as above in the preferred embodiment, it is not intended to limit the present application. Any technician familiar with the art can make many possible changes and modifications to the technical solution of the present application by using the methods and technical contents disclosed above, or modify it into an equivalent embodiment of equivalent changes, without departing from the scope of the technical solution of the present application. Therefore, any simple modification, equivalent change and modification made to the above embodiments based on the 10 technical essence of the present application without departing from the content of the technical solution of the present invention still falls within the scope of protection of the technical solution of the present application.

1. A document display method, the method comprising:
receiving a first access request triggered by a first user on a first document, wherein the first access request carries an identifier of a second document;
determining whether historical browsing status data of the second document exists based on the identifier of the second document; and
in response to the historical browsing status data existing, controlling a display of the second document based on the identifier of the second document and the historical browsing status data.

2. The method according to claim 1, wherein the controlling the display of the second document based on the identifier of the second document and the historical browsing status data comprises:
displaying the second document to the first user based on the identifier of the second document; and
controlling a browsing status of the second document based on the historical browsing status data, in response to it being determined that the second document is in a display status.

3. The method according to claim 1, wherein the method further comprises after receiving the first access request triggered by the first user on the first document:
acquiring first browsing status data, wherein the first browsing status data is configured to describe a browsing status of the first document in response to the first access request being triggered; and
establishing a correspondence between a first identifier and the first browsing status data, wherein the first identifier is configured to identify the first document;
wherein the determining whether historical browsing status data of the second document exists based on the identifier of the second document comprises:
determining whether there is a correspondence comprising the identifier of the second document, to obtain a determination result; and
determining whether the historical browsing status data of the second document exists based on the determination result.

4. The method according to claim 3, wherein the determining whether the historical browsing status data of the second document exists based on the determination result comprises:
in response to the determination result indicating that there is the correspondence comprising the identifier of the second document, extracting the historical browsing status data of the second document from the correspondence comprising the identifier of the second document; and
in response to the determination result indicating that there is no correspondence comprising the identifier of the second document, determining that the historical browsing status data of the second document does not exist.

5. The method according to claim 1, wherein the method further comprises after the controlling the display of the second document based on the identifier of the second document and the historical browsing status data:
deleting the historical browsing status data of the second document.

6. The method according to claim 5, further comprising:
obtaining second browsing status data, after receiving a second access request triggered by the first user on the second document, wherein the second browsing status data is configured to describe a browsing status of the second document in response to the second access request being triggered; and
establishing a correspondence between the identifier of the second document and the second browsing status data.

7. The method according to claim 1, further comprising:
in response to the historical browsing status data does not exist not existing, displaying the second document to the first user based on the identifier of the second document; or
in response to the first user meeting a preset user condition, displaying the second document to the second user based on a process of controlling of the display of the second document in response to it being determined that the second user meets a follow-up reading condition.

8. (canceled)

9. The method according to claim 7, wherein the second user is determined based on a document sharing scope, wherein the document sharing scope is determined based on a current conference participant.

10. (canceled)

11. A document display method for applying to a first interaction module, comprising:
receiving a first access request triggered by a first user on a first document, wherein the first access request carries identifier of a second document; and
sending the identifier of the second document to a first processing module, and sending, after obtaining historical browsing status data of the second document, the historical browsing status data to the first processing module, such that the first processing module controls a display of the second document based on the identifier of the second document and the historical browsing status data, wherein the historical browsing status data is obtained based on the identifier of the second document.

12. The method of claim 11, further comprising:
generating a document jump instruction based on the identifier of the second document;
wherein the sending the identifier of the second document to the first processing module comprises:
sending the document jump instruction to the first processing module, such that the first processing module displays the second document to the first user based on the identifier of the second document carried by the document jump instruction;
wherein the sending the historical browsing status data to the first processing module comprises:
sending the historical browsing status data to the first processing module after obtaining a status data query request sent by the first processing module, such that the first processing module controls a browsing status of the second document based on the historical browsing status data, wherein the status data query request is configured to request the first interaction module to provide the historical browsing status data.

13. The method according to claim 12, further comprising:
sending, after obtaining the status data query request sent by the first processing module, preset information to the first processing module in response to the historical browsing status data does not exist not existing, wherein the preset information is configured to indicate that the historical browsing status data does not exist in the first interaction module.

14. The method according to claim 12, wherein the method further comprises after the sending the document jump instruction to the first processing module:
obtaining first browsing status data sent by the first processing module, wherein the first browsing status data is configured to describe a browsing status of the first document in response to the first access request being triggered; and
establishing a correspondence between a first identifier and the first browsing status data, wherein the first identifier is configured to identify the first document;
wherein a process of obtaining the historical browsing status data comprises:
determining, after obtaining the correspondence comprising the identifier of the second document, the historical browsing status data of the second document from the correspondence comprising the identifier of the second document.

15. The method according to claim 11, further comprising:
deleting the historical browsing status data of the second document after obtaining control complete information sent by the first processing module, wherein the control complete information is configured to indicate that the first processing module has completed the controlling of the display of the second document.

16. The method according to claim 11, further comprising:
in response to the first user meeting a preset user condition, sending a document follow-up instruction to a second interaction module in response to it being determined that a second user meets a follow-up reading condition, such that the second interaction module controls a second processing module to follow up the controlling of the display of the second document by the first processing module,
wherein the second user is determined based on a document sharing scope.

17. (canceled)

18. The method according to claim 17, wherein the document sharing scope is determined based on a current conference participant.

19. A document display method for applying to a first processing module, comprising:
receiving an identifier of a second document and historical browsing status data of the second document sent by a first interaction module in response to the first processing module being displaying a first document; and
controlling a display of the second document based on the identifier of the second document and the historical browsing status data of the second document, such that the first processing module starts to display the second document.

20. The method according to claim 19, wherein the controlling the display of the second document comprises:
displaying, after receiving a document jump instruction sent by the first interaction module, the second document to a first user based on the identifier of the second document carried by the document jump instruction;
generating a status data query request based on the identifier of the second document;
sending the status data query request to the first interaction module;
obtaining a status data query result fed back by the first interaction module, for the status data query request; and
in response to the status data query result carrying the historical browsing status data of the second document, controlling a browsing status of the second document based on the historical browsing status data.

21. (canceled)

22. The method according to claim 20, wherein the method further comprises after receiving the document jump instruction sent by the first interaction module:
sending first browsing status data to the first interaction module, wherein the first browsing status data is configured to describe a browsing status of the first document in response to receiving the document jump instruction sent by the first interaction module.

23. The method according to claim 22, wherein the first browsing status data is determined based on a historical browsing operation of the first user on the first document, and the historical browsing operation is configured to indicate a document browsing operation triggered by the first user on the first document before receiving the document jump instruction sent by the first interaction module, or
wherein the first browsing status data is determined based on document location information of the identifier of the second document, and the document location information is configured to indicate a position of the identifier of the second document on the first document.

24. The method according to claim 19, wherein the method further comprises after controlling the display of the second document based on the identifier of the second document and the historical browsing status data of the second document:
generating control complete information based on the identifier of the second document; and
sending the control complete information to the first interaction module, such that the first interaction module deletes the historical browsing status data of the second document.

25. (canceled)

26. (canceled)

27. (canceled)

28. (canceled)
